(19) United States
(12) Patent Application Publication
(10) Pub. No.: US 2022/0190419 A1
(43) Pub. Date: Jun. 16, 2022

(54) HONEYCOMB-LIKE ENERGY STORAGE CELL RECEPTACLE, RECHARGEABLE BATTERY PACK, AND METHOD FOR PRODUCING A RECHARGEABLE BATTERY PACK

(71) Applicant: stoba e-Systems GmbH, Weinstadt (DE)

(72) Inventors: Andreas BRENNER, Esslingen (DE); Manuel GRAUER, Weinstadt (DE); Nikica SERIC, Stuttgart (DE)

(21) Appl. No.: 17/599,794

(22) PCT Filed: Mar. 30, 2020
(86) PCT No.: PCT/EP2020/058999

§ 371 Date: Sep. 29, 2021

(30) Foreign Application Priority Data
Apr. 1, 2019 (DE) 10 2019 108 453.9

(51) Int. Cl. H01M 50/213; H01M 50/503; H01M 50/107; B60L 50/64

(52) U.S. Cl. CPC H01M 50/213; H01M 50/503; H01M 2220/20; B60L 50/64; H01M 50/107

(57) ABSTRACT

The invention relates to a motor vehicle energy storage cell receptacle (1) for fixing and/or contacting a plurality of energy storage cells (2), having two receiving devices (3) between which the energy storage cells (2) are held, wherein: the energy storage cells (2) each have plus-pole and minus-pole contact elements; the receiving devices (3) each have at least one carrier plate (4) and at least one contact plate (5); and both the carrier plate (4) and the contact plate (5) have a honeycomb-like structure for receiving the plurality of energy storage cells (2). The invention further relates to a rechargeable battery pack (15) having a motor vehicle energy storage cell receptacle (1) and a method for producing a rechargeable battery pack (15).

The invention relates to an energy storage cell receptacle for fixing and/or contacting a plurality of energy storage cells, a rechargeable battery pack comprising an energy storage cell receptacle, and a method for producing a rechargeable battery pack.

Rechargeable battery packs are already known from the prior art. For example, DE 20 2014 008 335 U1 discloses a rechargeable battery pack for an electric vehicle, wherein a rechargeable battery module is arranged on a base plate and is constructed from identical basic rechargeable battery modules that can be connected to form larger subunits, in particular a rechargeable battery submodule, wherein a layer of flame-retardant material is provided between the base plate and the rechargeable battery module and on the other side of the rechargeable battery module.

So far, holders have been realized on a rigid grid structure, usually manufactured in a forming process, which in its smallest unit does not allow any flexibility. These variants are usually connected to the contact plate in a form-fit or force-fit manner, wherein the ‘+’ and the ‘−’ side are subsequently fixed in a housing. These solutions offer good controllability of the tolerances, but are greatly limited in their flexibility.

Furthermore, holders have been offered in a wide variety of designs as plug-in systems, which offer a high degree of flexibility. However, the control of the occurring tolerance chains is very difficult here and the contacting in connection with a moderate fixability of the ‘+’ and the ‘−’ side is to be rated as rather poor.

In summary, the designs according to the prior art are disadvantageous in that, on the one hand, flexibility, in particular external contour flexibility, is not given and, on the other hand, contacting and holding of the rechargeable battery cells is realized with moderate fixability.

It is the object of the invention to provide an energy storage cell receptacle which eliminates or at least reduces the disadvantages of the prior art. Accordingly, a flexible device is to be provided which at the same time enables secure holding and contacting of rechargeable battery cells.

The object of the invention is solved in a device according to the invention in that an energy storage cell receptacle for fixing and/or contacting a plurality of energy storage cells is configured with two receiving devices between which the energy storage cells are held, wherein the energy storage cells each have plus and minus pole contact elements, wherein the receiving devices each have at least one carrier plate/cell holder/carrier structure and at least one contact plate, wherein both the carrier plate/cell holder and the contact plate have/comprise a honeycomb-like structure for receiving the plurality of energy storage cells.

In this way, the invention provides a highly flexible and sustainable way of holding and contacting rechargeable battery cells with a completely different solution for connecting the holding elements and contact elements from the ‘+’ and the ‘-’ side.

The arrangement, which corresponds to a honeycomb-like arrangement of energy storage cells, has the advantage of efficient use of installation space. Nevertheless, such an arrangement offers enough space between the individual energy storage cells for cooling the cells using a fluid, for example.

Furthermore, this generic device has the advantage that the definition of the cell arrangement can be manufactured at low cost.

Advantageous embodiments are claimed in the dependent claims and are explained in more detail below.

For example, it is practical if the carrier plate has interconnected partial receptacles formed in hexagonal shape on the outside, wherein each partial receptacle has an inner contour which is dimensioned to hold an energy storage cell in a force-fit and/or form-fit manner. In other words, this means that the individually formed, hexagonal partial receptacles are arranged next to each other, thus forming a, preferably closed, flat carrier plate with a honeycomb structure.

Furthermore, it is advantageous if at least one or more partial receptacle(s) is/are connected on the outside to at least one or more similar partial receptacle(s). In this case, a circumferential wall of a partial receptacle is brought into contact with a circumferential wall of an adjacent partial receptacle. This ensures a space-efficient design.

It is preferred if the partial receptacle has at least one axial-position limiting device for the energy storage cell, which is oriented such that it comes into contact with the front side of the energy storage cell or is arranged adjacent to the front side of the energy storage cell in the state in which the energy storage cell is inserted into the carrier plate.

Furthermore, it is practical if two opposite axial-position limiting devices reach over an energy storage cell when this energy storage cell is arranged within the circumferential wall of a partial receptacle. In other words, the axial-position limiting devices define the position of the battery to be received in the axial direction.

It is therefore practical if each axial-position limiting device has a hook-like, lug-like or boomerang-like shape. In other words, each axial-position limiting device has two legs, preferably of equal length, projecting inwards into the partial receptacle, which are connected to a further leg parallel to a side edge of the hexagon.

A further advantage arises if the contact plate has a number of frames which are formed in hexagonal shape on the inside and outside and which are connected integrally/in one piece with each other or which are attached to each other as separate structures. It is preferred if the formed frames of the contact plate correspond in shape and size to the partial receptacles of the carrier plate.

In particular, it is practical if a contact cross-piece is formed as a web-like connection between two opposite corners of the frame formed in hexagonal shape. Among other things, this has the advantage that the contact cross-piece serves on the one hand as electrical contact with the energy storage cell and on the other hand that the contact cross-piece formed in this way gives stability to the frame with its hexagonal shape.

It is preferred if the axial-position limiting devices of a partial receptacle converge and define a distance area between them which is exactly covered or filled by a contact cross-piece of a frame formed in hexagonal shape of the axial contact plate. In other words, the width of the contact cross-piece is less than ⅕ of the length of an unwound axial-position limiting device.

Furthermore, it is advantageous if the thickness of the contact cross-piece measured in the axial direction corresponds, preferably exactly, to the thickness of the axial-position limiting device measured in the axial direction. In addition, it is practical if all contact cross-pieces are formed parallel to each other.

In addition, it is practical if the carrier plate is provided as a support body for receiving the plurality of energy storage cells and is formed in plate form, preferably by plastic injection molding or by compression molding. In other words, a support geometry is developed on the basis of this honeycomb-like structure, which is produced in plate form, for example by plastic injection molding or by compression molding. It is advantageous here that the carrier plate is preferably made of plastic, on the one hand, in order not to have any conductive properties and, on the other hand, to provide a sufficient support function in combination with the honeycomb-like structure and the associated support geometry.

It is preferred if the contact plate is provided for electrically contacting the plurality of energy storage cells and is formed in plate form, preferably by stamping or by forming. In other words, a contact plate is produced to match the carrier plate, also as a plate, for example in a stamping or forming process.

It is practical if the at least one contact plate is clamped in a form-fit or force-fit manner with the at least one carrier plate. In other words, this means that the one contact plate and the carrier plate are clamped in a form-fit manner or are alternatively force-fitted to each other in a process similar to the sewing/bandaging process of a stator or rotor winding head, depending on the requirements of the subsequent application/use.

A sewing/bandaging process in the present application is to be understood as a process in which the at least one contact plate is joined to the at least one carrier plate in such a way that it resembles a sewing or bandaging process generally known from the textile sector. This process thus describes the joining of materials of the same or different types via a seam, which has the advantage that seam joints are considered to be very stable and resilient.

Furthermore, it is advantageous if the composite of the at least one contact plate with the at least one carrier plate is configured to adapt the shape and size along the honeycomb-like structure, preferably flexibly, to a shape and size corresponding to an intended use. In other words, this means that the composite of the carrier plate/supporting body plate and contact plate is in turn, after joining, very flexibly shaped by a shearing or sawing process along the honeycomb structure into a shape serving the subsequent intended use. In other words, the geometric design of the bodies can be optimized for later, flexible shaping of energy storage cell bundles by shearing and/or sawing. Accordingly, the contact elements/energy storage cell poles and the contact plate can be contacted with each other.

It is furthermore preferred if the plus pole contact elements of the plurality of energy storage cells are connected to a first contact plate by joining, in particular welding, or a process similar to the sewing/bandaging process of a stator or rotor winding head, and the minus pole contact elements of the plurality of energy storage cells are connected to a second contact plate by joining, in particular welding, or a process similar to the sewing/bandaging process of a stator or rotor winding head. In other words, the ‘+’ and the ‘-’ side of the individual energy storage cells to be received can be connected either by joining, such as welding, of the pole/contact element and the contact plate, or by a process similar to sewing.

For this purpose, it is practical if the first contact plate is arranged opposite the second contact plate.

Furthermore, the invention also relates to a rechargeable battery pack or respectively an ‘InED rechargeable battery pack’ comprising an energy storage cell receptacle according to one of the preceding aspects, wherein the first and second contact plates respectively form the upper and lower outer sides of a rechargeable battery pack comprising two receiving devices and a plurality of energy storage cells arranged therebetween. Thus, the rechargeable battery pack is constructed in the following order of a first bottom contact plate, a first carrier plate, a plurality of energy storage cells, then a second carrier plate, and then a second top contact plate.

It is advantageous if a central hole is arranged in the center of a contact cross-piece which is dimensioned such that a contact element of one of the plurality of energy storage cells engages to establish an electrical contact, preferably in a form-fit and/or force-fit manner, when the rechargeable battery pack is completed. This has the advantage that the energy storage cells correspond to a position predetermined by the respective central holes via the engagement of the contact elements/poles of each energy storage cell and are adapted to be fixed accordingly.

It is preferred if half the thickness of the energy storage cell receptacle measured in the axial direction is less than one third of the thickness or respectively height of an energy storage cell measured in the axial direction.

In summary, the hexagonal grid structure made of preferably reinforced plastic is used for force-fit and form-fit reception or respectively fixing of a plurality of cylindrical energy storage cells, in particular 18650 or 21700, and an associated, geometrically similar/identical, electrically conductive contact plate as a common connection of the energy storage cells with the respective plus or minus pole.

The modular, interconnectable concept thus allows a high degree of flexibility of the outer geometric contour or respectively of the outline of the energy storage cell receptacle or respectively of the cell holder or cell unit. In addition to simple and cost-effective production due to the largely standardized basic shape for the carrier plate and the contact plate, an arrangement that is protected against polarity reversal results due to grouping the energy storage cells with the same orientation.

The invention also relates to a method for producing a rechargeable battery pack according to the preceding aspects with respect to the rechargeable battery pack, wherein at least one carrier plate is injection molded, preferably plastic injection molded, or compression molded, at least one contact plate is stamped or formed, and both the carrier plate and the contact plate are formed by a honeycomb-like structure for receiving the plurality of energy storage cells.

This has the advantage that such a geometry optimization and process adaptation makes it possible to increase the sustainability of the components and the assembly of the energy storage cell receptacle with appropriate pole/contact element contacting.

The present invention thus offers a high degree of flexibility in shaping the subsequent energy storage cell bundles while at the same time providing very good control of the tolerances in all spatial directions. Furthermore, the optimized geometry makes it possible to standardize the basic components. This has the advantage of lower costs in the value chain.

The invention is explained hereinafter with the aid of the drawings. They show:

FIG. 1 shows a schematic representation of a receiving device of an energy storage cell receptacle,

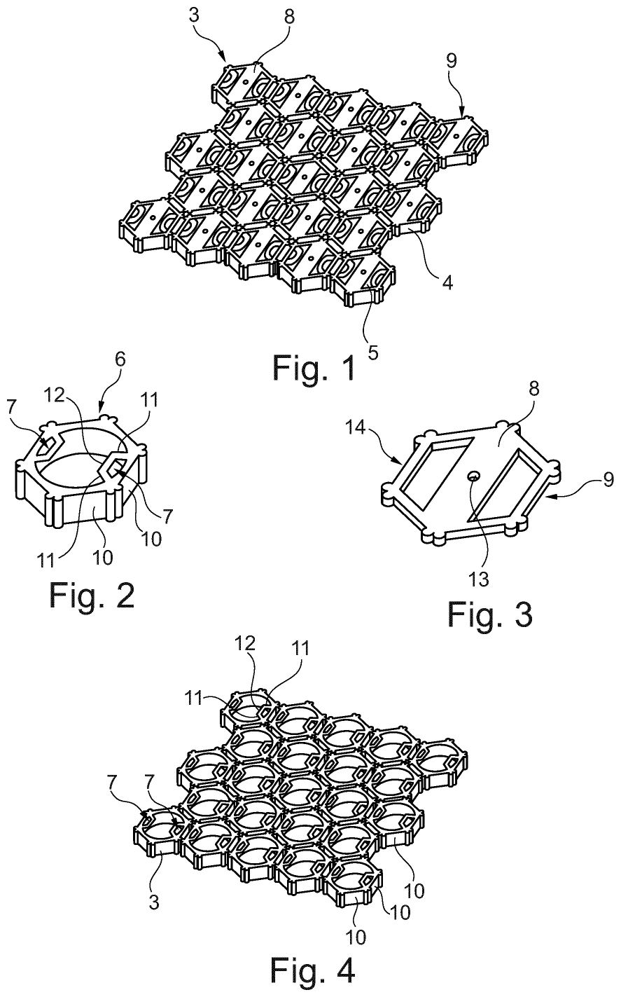

FIG. 2 shows a schematic representation of a partial receptacle of the carrier plate,

FIG. 3 shows a schematic representation of a frame of the contact plate for contacting a contact element of an energy storage cell,

FIG. 4 shows a schematic representation of a carrier plate of one of the receiving devices,

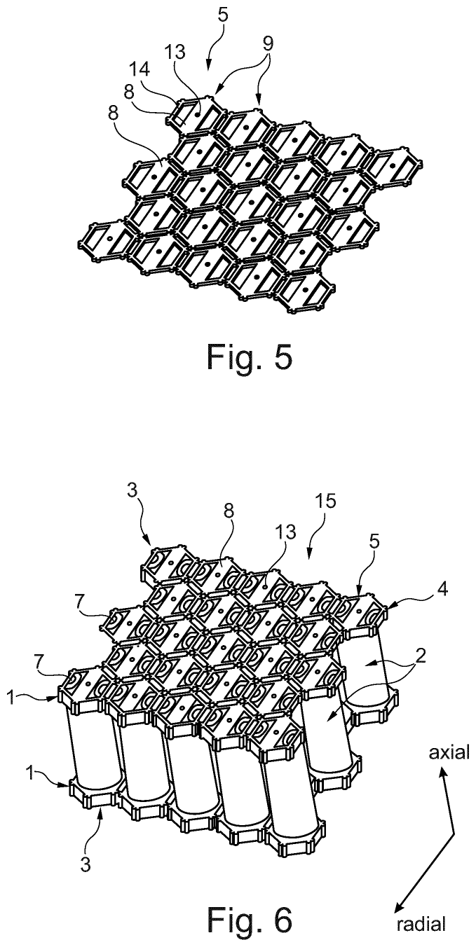

FIG. 5 shows a schematic representation of a contact plate of one of the receiving devices, and

FIG. 6 shows a schematic representation of a rechargeable battery pack.

The figures are merely schematic in nature and only serve the purpose of understanding the invention. Identical elements are provided with the same reference signs.

An automotive energy storage cell receptacle 1 for fixing and/or contacting a plurality of energy storage cells 2 has two receiving devices 3. FIG. 1 shows a schematic representation of such a receiving device 3 of an energy storage cell receptacle 1 according to the present disclosure. Such a receiving device 3 has a respective carrier plate 4 and a contact plate 5. As can be seen in FIG. 1, both the carrier plate 4 and the contact plate 5 have a honeycomb-like structure for receiving the plurality of energy storage cells 2.

In FIG. 1, it can be seen that the contact plate 5 is attached to the carrier plate 4. Furthermore, the structure/shape and size of the contact plate 5 is adapted to the structure/shape and size of the carrier plate 4. As described in more detail below with reference to FIG. 2, a partial receptacle 6 of the carrier plate 4 is formed with two axial-position limiting devices 7. Between these axial-position limiting devices 7 of a partial receptacle 6 lies a contact cross-piece 8 of a frame 9 formed in hexagonal shape of the contact plate 5, as described in more detail with reference to FIG. 3.

As indicated in FIG. 1, the thickness in the axial direction of the contact plate 5 is about 1/10 of the thickness of the carrier plate 4.

FIG. 2 is a schematic representation of a partial receptacle 6 of the carrier plate 4 according to the present disclosure. Each of the hexagonal partial receptacles 6 has six side edges, which are hereinafter referred to as circumferential walls 8. The outer sides of the circumferential walls 8 are configured to be lined up so as to form a planar carrier plate 4.

A defined number of partial receptacles 6 in combination with a number of frames 9 lying on the partial receptacles 6 defined according to the number of partial receptacles 6 are brought into contact with each other and thus form one of the two receiving devices 3.

An axial-position limiting device 7 is mounted on each of two opposite circumferential walls 10. The axial-position limiting device 7 has a lug-like design. Geometrically, each of the axial-position limiting devices 7 has a first and a second leg 11, which are preferably of equal length/size and preferably start at a corner point of the hexagonal partial receptacle 6, and which project into the interior of the respective partial receptacle 6 at a predetermined, preferably identical angle. The first and the second leg 11 are connected on one side via the circumferential wall 10 of the partial receptacle 6 and with a third leg 12 aligned parallel to the corresponding circumferential wall 10.

Furthermore, according to FIG. 2, it is provided that only the outer contour of the partial receptacle 6 has a hexagonal shape and the inner contour of the partial receptacle 6 has a shape/geometry corresponding to the shape/geometry of the energy storage cell 2 to be received. Preferably, cylindrical energy storage cells 2, preferably batteries or rechargeable batteries, are received and the inner contour of the partial receptacle 6 is thus preferably circular.

FIG. 3 shows a schematic representation of a frame 9 of the contact plate 5 for contacting a contact element of an energy storage cell 2 according to the present disclosure. The contact cross-piece 8 extends from a corner point of the hexagonal frame 9 to a corner point opposite thereto. Preferably, the contact cross-piece 8 of a frame 9 has a maximum width such that it makes up ⅓ of the total width of the frame 9.

Each frame 9 has a central hole 13 in the center. The central hole 13 is provided in the contact cross-piece 8 and serves to receive a contact element of a corresponding energy storage cell 2. Such a contact element (not shown) is formed in each case on the front side of an energy storage cell 2, once as a plus pole and once as a minus pole. In addition, the central hole 13 is used to arrange the corresponding energy storage cells 2 in a specific position. The contact cross-piece 8 is oriented parallel to the two side frame edges 14 which are not in contact with it.

FIG. 4 is a schematic representation of a carrier plate 4 of one of the receiving devices 3 according to the present disclosure. The carrier plate 4 has interconnected partial receptacles 6 formed in hexagonal shape on the outside (as shown in FIG. 2). At least one or more partial receptacle(s) 6 is/are connected on the outside to at least one or more similar partial receptacle(s) 6. The axial-position limiting devices 7 are oriented in the same direction in each partial receptacle 6 according to FIG. 4. Thus, all third legs 12 of the connected partial receptacles 6 are arranged/oriented parallel to each other.

FIG. 5 shows a schematic representation of a contact plate 5 of one of the receiving devices 3 according to the present disclosure. The contact plate 5 has interconnected inner and outer frames 9 (as shown in FIG. 3) formed in hexagonal shape. The arrangement of the frames 9 corresponds to the arrangement of the partial receptacles 6. The contact cross-pieces 8 of all interconnected frames 9 are oriented parallel to each other.

FIG. 6 shows a schematic representation of a rechargeable battery pack 15 according to the present disclosure. The rechargeable battery pack 15 has a top side which is formed by a contact plate 5. The first contact plate 5 rests on or is fixed to a first carrier plate 4. The partial receptacles 6 of the first carrier plate 4 receive the energy storage cells 2. The position of the energy storage cells 2 is determined by the partial receptacles 6 and limited in the axial direction by the axial-position limiting devices 7. The contact elements/poles (not shown) of the energy storage cells 2 engage in the respective central hole 13 in the respective contact cross-piece 8 of the top contact plate 5 and are electrically connected to it.

A corresponding arrangement is provided on the underside of the rechargeable battery pack 15. Accordingly, the underside of the rechargeable battery pack 15 has a contact plate 5 which is brought into contact with the carrier plate 4 and the carrier plate 4 in turn receives the other side of the energy storage cells 2. Thus, either all energy storage cells 2 have their ‘-’ side on the underside of the rechargeable battery pack 15 and their ‘+’ side on the top side of the rechargeable battery pack 15 or vice versa.

As shown in FIG. 6, the individual energy storage cells 2 are connected to each other exclusively via the contact plate 5 and the carrier plate 4. Air slots are provided between the energy storage cells 2 in the area of the energy storage cells 2 located between the two receiving devices 3. In this way, cooling in the form of an air flow of the energy storage cells 2 can be provided or overheating can be prevent.

### LIST OF REFERENCE SIGNS

1 energy storage cell receptacle
2 energy storage cells
3 receiving device
4 carrier plate
5 contact plate
6 partial receptacle
7 axial-position limiting device
8 contact cross-piece
9 frame
10 circumferential wall
11 first and second leg
12 third leg
13 central hole
14 side frame edge
15 rechargeable battery pack

1. An automotive energy storage cell receptacle for fixing and/or contacting a plurality of energy storage cells with two receiving devices between which the energy storage cells are held, wherein the energy storage cells each have plus and minus pole contact elements, wherein the receiving devices each have at least one carrier plate and at least one contact plate for electrical contacting, which is clamped in a form-fit or force-fit manner to the at least one carrier plate, wherein both the carrier plate and the contact plate have a honeycomb-like structure for receiving the plurality of energy storage cells, wherein the carrier plate has interconnected partial receptacles formed in hexagonal shape on the outside and the contact plate has frames which are interconnected, wherein each frame is formed in hexagonal shape on the inside and outside.

2. The automotive energy storage cell receptacle according to claim 1, wherein the carrier plate is provided as a supporting body for receiving the plurality of energy storage cells and is formed in plate form.

3. The automotive energy storage cell receptacle according to claim 1, wherein the contact plate is provided for contacting the plurality of energy storage cells and is formed in plate form.

4. The automotive energy storage cell receptacle according to claim 1, wherein at least one contact plate has a contact cross-piece as electrical contact with an energy storage cell.

5. The automotive energy storage cell receptacle according to claim, wherein the plus pole contact elements of the plurality of energy storage cells are connected by joining or by a process similar to sewing to a first contact plate and the minus pole contact elements of the plurality of energy storage cells are connected by joining or by a process similar to sewing to a second contact plate.

6. The automotive energy storage cell receptacle according to claim 5, wherein the first contact plate is arranged opposite the second contact plate.

7. A rechargeable battery pack comprising an automotive energy storage cell receptacle according to claim 5, wherein the first and second contact plate respectively form the upper and lower outer sides of the rechargeable battery pack comprising two receiving devices and a plurality of energy storage cells arranged therebetween.

8. The rechargeable battery pack according to claim 7, wherein a central hole is arranged in the center of a contact cross-piece in the contact plate, wherein the contact cross-piece is dimensioned such that a contact element of one of the plurality of energy storage cells engages to establish electrical contact when the rechargeable battery pack is completed.

9. A method of producing a rechargeable battery pack according to claim 7, wherein at least one carrier plate is injection molded or compression molded, at least one contact plate is stamped or formed, and both the carrier plate and the contact plate are formed by a honeycomb-like structure for receiving the plurality of energy storage cells.
